(19) United States
(12) Patent Application Publication
(10) Pub. No.: US 2011/0226847 A1
(43) Pub. Date: Sep. 22, 2011

(54) PACKING BOX, CORRUGATED CARDBOARD BLANK SHEET AND RULING WHEEL ASSEMBLY

(75) Inventor: Tomoharu Nakano, Tokyo (JP)

(73) Assignee: Suntory Holdings Limited, Osaka-shi (JP)

(21) Appl. No.: 12/671,791

(22) PCT Filed: Aug. 1, 2008
(86) PCT No.: PCT/JP2008/063854

§ 371 Date: Feb. 2, 2010

(30) Foreign Application Priority Data
Aug. 3, 2007 (JP) 2007-203374
Jan. 10, 2008 (JP) 2008-003199
Jul. 31, 2008 (JP) 2008-197738

(51) Int. Cl. B26D 5/42; B31B 3/00

(52) U.S. Cl. 229/198.2; 493/162

(57) ABSTRACT

An object of the present invention is to provide a packing box having its ridge(s) collapsed so that there would be no body bulging occurring in the box and potential serpentine folding line would be avoided.

Provided is a packing box having a top panel 3, a bottom panel 7, two long side panels and two short side panels, in which at least either one of a ridge defined between said top panel and said long side panel or a ridge defined between said bottom panel and said long side panel is formed by at least two parallel rules configured to be different in depth from adjacent one.

### TECHNICAL FIELD

The present invention relates to a packing box, a corrugated cardboard blank sheet and a ruling wheel assembly, and more specifically to packing boxes that can be stacked with heavy goods, such as canned containers, contained therein, a corrugated cardboard blank sheet therefore as well as a ruling wheel for producing a ruled line in the corrugated cardboard blank sheet.

### BACKGROUND ART

Conventionally, a packing box made of corrugated cardboard has been commonly used for packaging a wide variety of products. When a number of such packing boxes are stored in a relatively highly humid environment as they are stacked with heavy goods contained therein, a phenomenon so called “body bulging” characterized in an outwardly bulging side panel may occur in a packing box placed in a lower level in the stack due to a load applied from a packing box stacked over the box, as shown in FIG. 26. The term “body bulging” as used herein not only refers to bulging outwardly but also includes being depressed inwardly and being deformed in an S-shaped configuration with both depression and bulge appearing in the packing box. This may be caused by a load applied to a packing box 501a from above to distort a top and a bottom panel of the packing box, which distortion may affect even to the side panel of the packing box. Such phenomenon of body bulging as described above may cause a problem of unattractive appearance and the like in a retail shop selling the products.

Many different approaches have been made according to the related art to prevent the phenomenon of body bulging as stated above. For example, a first approach according to the related art is directed to a packing box having a single rule and two rules offset in parallel to each other, which are alternately arranged with a cut therebetween, in a boundary area between two sheets of panel material (see Patent document 1). With such a configuration employed, if any load from the stacking affects the packing box, a folding angle of the two parallel rules will vary so as to absorb any height-wise deformation of the packing box, thereby inhibiting the phenomenon of body bulging.

In addition, a second approach according to the related art is directed to a packing box having a number of paired two diagonal rules arranged in a repeated manner in a boundary area between two sheets of panel material (see Patent document 2). With such a configuration employed, if any load from the stacking affects the packing box, a folding angle of the two diagonal rules will vary so as to absorb the body bulging in a similar manner to the case of Patent document 1.

Furthermore, a third approach according to the related art is directed to a packing box having a buckling guide line in a lozenge shape provided by a pressed line in a ridge area between a side panel and a flat panel (see Patent document 3). With such a configuration employed, during manufacturing a packing box, a corrugated cardboard blank sheet can be folded along the buckling guide line, thereby preventing any defective packing box from being manufactured. In addition, when a load from the stacking affects the packing box, the buckling guide line in response to a varied folding angle also can absorb any height-wise deformation of the packing box so as to inhibit the phenomenon of body bulging.

In addition, a fourth approach according to the related art is directed to a packing box having a lengthwise ridge defined by a side panel meeting a top panel and/or a bottom panel that has been chamfered (see Patent document 4). With such configuration employed, if any load from the staking affects a packing box, the panels can be moved horizontally as maintained in a flat surface configuration, thereby inhibiting the body bulging and also contributing in making any change in side panel contour indistinct.
Patent document 1: Japanese Patent Laid-open Publication No. 2004-10065
Patent document 2: Japanese Patent Laid-open Publication No. 2004-59001
Patent document 3: Japanese Patent Laid-open Publication No. 2005-67698
Patent document 4: Japanese Patent Laid-open Publication No. 2006-306497

### DISCLOSURE OF THE INVENTION

### Problem to be Solved by Invention

However, those types of packing box as disclosed in the cited Patent documents 1 and 2 require that a part of the box should be cut out or a predetermined cut should be formed in the box. Consequently, there may be a possible case of any foreign objects, such as dust or the like entering from the cut-out or cut-in area. In addition, the packing box as disclosed in a cited Patent document 3 needs a specific geometry of pressing ruler for creating the lozenge shape of the buckling guide line.

Further, there is a problem with the packing box according to the cited Patent document 4, including that if the packing box is manufactured by using a caser (an apparatus for box manufacturing, in which a corrugated cardboard blank sheet in a flat panel configuration may be formed into a packing box) of a conventional type, a folding line in the ridge could run serpentine and thus inhibit excellent box manufacturing precision from being obtained.

### Means for Solving the Problems

An object of the present invention is to provide a packing box that can solve the problems as pointed above. To accomplish the above object, provided in claim 1 in “What is claimed is” is a packing box having a top panel, a bottom panel, two long side panels and two short side panels, the box having employed such a configuration in which at least either one of a ridge defined between the top panel and the long side panel or a ridge defined between the bottom panel and the long side panel is formed by at least two parallel rules configured to be different in depth from adjacent one. With the box configured as described above, one of the rules of the packing box having a greater depth may have a reduced rigidity. Consequently, when a bending stress affects the packing box, the one of the rules having the reduced rigidity will first start to bend. Thus, even with the existing caser, the box can be manufactured properly without folding line running serpentine. In addition, the packing box, once manufactured properly, can be inhibited from body-bulging even upon effecting of a stacking load.

Provided in claim 2 is a packing box having a top panel, a bottom panel, two long side panels and two short side panels, the packing box having employed such a configuration in which at least either one of a ridge defined between the top panel and the long side panel or a ridge defined between the bottom panel and the long side panel is formed by a single rule having a predetermined width and having a varying depth depending on its widthwise location. With such a configuration employed, the corrugated cardboard blank sheet will bend first along an area of the rule that has been collapsed most deeply. This may work similarly to the invention as defined in claim 1.

Provided in claim 3 is a packing box having employed such a configuration in which the depth of the rule varies serially. With such a configuration employed, in addition to the effect that the corrugated cardboard blank sheet will bend first along the area of the rule that has been collapsed most deeply, the ridge of the packing box can bend in a curved surface configuration owing to the bending rigidity varying continuously within the rule. Such a ridge can also inhibit the body bulging equally to the inventions as defined above.

Further, provided in claim 4 is a packing box having employed such a configuration in which the depth of the rule varies in steps. With such a configuration employed, in addition to the effect that the corrugated cardboard blank sheet will bend first along the area of the rule that has been collapsed most deeply, the ridge of the packing box can bend in a polygonal configuration owing to the bending rigidity varying in steps within the rule. Such a ridge can also inhibit the body bulging equally to the inventions as defined above.

Further, provided in claim 5 is a packing box having employed such a configuration in which perforations are formed at least in either one of said at least two parallel rules configured to be different in depth from adjacent one, the perforations running along the rule. With the packing box configured as described above, the one made of material having a higher rigidity still can be reliably folded at the rule with the effect from the perforations. Additionally, the caser (box manufacturing apparatus) operating at a higher rate still can manufacture the boxes in a stable manner.

Provided in claim 6 is a packing box having employed such a configuration in which the perforations are formed at least in a shallowest rule. With the packing box configured as described above, the one including the shallower rule that has a higher bending rigidity still can be folded reliably at the shallower rule with the effect from the perforations.

Further, provided in claim 7 is a packing box having employed such a configuration in which perforations are formed in either one of a deeper side or a shallower side of the single rule having a varying depth depending on its widthwise location, the perforations running along the rule. With the box configured as described above, the one made of material having a higher rigidity still can be reliably folded at the rule with the effect from the perforations. Additionally, the caser (box manufacturing apparatus) operating at a higher rate still can manufacture the boxes in a stable manner.

Further, provided in claim 8 is a packing box having employed such a configuration in which the perforations are formed in a shallower side within the rule. With the box configured as described above, the one having a higher rigidity in the shallower side within the rule still can be reliably folded at the rule in the shallower side thereof with the effect from the perforations.

Further, provided in claim 9 is a ruling wheel assembly comprising one of ruling wheels in a disc- or roller-like configuration having a convex portion in its side surface and the other of the ruling wheels in a disc- or roller-like configuration whose side surface provides a circumferential surface or a concave portion to mate with the convex portion of the one of the ruling wheels, the ruling wheel assembly having employed such a configuration in which the one and the other of the ruling wheels are supported on rotatable shafts extending parallel to each other and positioned so that the side surfaces thereof are proximal to each other, wherein a rule is produced in a paper material by the ruling wheel provided with the convex portion.

Further, provided in claim 10 is a ruling wheel assembly having employed such a configuration in which an end surface of the convex portion is beveled with respect to an axial direction of the rotatable shaft.

Further, provided in claim 11 is a ruling wheel assembly comprising one of ruling wheels in a disc- or roller-like configuration having a convex portion in its side surface and the other of the ruling wheels in a disc- or roller-like configuration whose side surface provides a circumferential surface or a concave portion to mate with the convex portion of the one of the ruling wheels, the ruling wheel assembly having employed such a configuration in which the one and the other of the ruling wheels are supported on rotatable shafts extending parallel to each other and positioned so that the side surfaces thereof are proximal to each other, wherein two pairs of the convex and the concave portions are provided in the assembly.

Further, provided in claim 12 is a ruling wheel assembly having employed such a configuration in which the two convex portions are different in height from each other.

Further, provided in claim 13 is a ruling wheel assembly having employed such a configuration in which the two concave portions are different in depth from each other.

Further, provided in claim 14 is a ruling wheel assembly having employed such a configuration in which the concave portion is formed by two protrusions provided in the other of the ruling wheels, the protrusions tapered toward tips thereof.

Further, provided in claim 15 is a ruling wheel assembly having employed such a configuration in which the convex portion is formed by two first protrusions and the concave portion is formed by two second protrusions disposed to sandwich the two first protrusions therebetween.

Further, provided in claim 16 is a corrugated cardboard blank sheet having employed such a configuration in which a rule has been produced by a ruling wheel assembly of any one of the types as defined above.

Further, provided in claim 17 is a packing box having employed such a configuration in which the packing box is formed from a corrugated cardboard blank sheet as defined above.

Further, provided in claim 18 is a packing box having employed such a configuration in which the corrugated cardboard blank sheet has been folded in a mountain fashion at a rule produced by a ruling wheel provided with the convex portion.

### Advantages of the Invention

According to the present invention, the two rule configured to be different in depth that have been produced at the location corresponding to the ridge of the packing box can solve a problem of potential serpentine folding line appearing in the ridge even with the existing caser. Further, the rule having a predetermined width but having a varying depth depending on the widthwise location, that has been produced in the ridge of the packing box, can also inhibit the potential serpentine folding line. Besides, the packing box using a material having a higher bending rigidity can be yet reliably folded at the rule with the effect from the perforations. In addition, such a specified rule as described above can be easily produced by using a ruling wheel assembly having a particular configuration.

### BRIEF DESCRIPTION OF THE DRAWINGS

FIG. 1 shows a plan view of a packing box in its developed configuration according to an embodiment of the present invention;

FIG. 2 presents an enlarged view of an encircled area of the packing box as shown in FIG. 1, wherein FIG. 2(A) shows a plan view and FIG. 2(B) shows a sectional view taken along the B-B line of FIG. 2(A), respectively;

FIG. 3 presents a packing box that has been formed by using the packing box as disclosed in FIG. 1, wherein FIG. 3(A) shows a side elevational view and FIG. 3(B) shows a perspective view of the packing box, respectively;

FIG. 4 presents a partially enlarged view of a packing box according to a second embodiment of the present invention, wherein FIG. 4(A) shows a plan view, FIG. 4(B) shows a sectional view taken along the B-B line of FIG. 4(A) and FIG. 4(C) shows a variation of FIG. 4(B), respectively;

FIG. 5 presents a partially enlarged view of a packing box according to a third embodiment of the present invention, wherein FIG. 5(A) shows a plan view, FIG. 5(B) shows a sectional view taken along the B-B line of FIG. 5(A) and FIG. 5(C) shows a variation of FIG. 5(B), respectively;

FIG. 6 presents a packing box that has been formed by using a packing box according to a fourth embodiment of the present invention, wherein FIG. 6(A) shows a side elevational view and FIG. 6(B) shows a perspective view of the packing box, respectively;

FIG. 7 is a perspective view for illustrating an aspect in which the packing box as disclosed in FIG. 6 is used;

FIG. 8 presents a partially enlarged perspective view of two rules in a packing box according to a fifth embodiment of the present invention, wherein FIG. 8(A) shows a case of perforations formed exclusively in a front liner and FIG. 8(B) shows a case of perforations formed not only in a front liner but also in a back liner and a core layer, respectively;

FIG. 9 presents a partially enlarged perspective view of a wide rule in a packing box according to a sixth embodiment of the present invention, wherein FIG. 9(A) shows a case of perforations formed exclusively in a front liner and FIG. 9(B) shows a case of perforations formed not only in a front liner but also in a back liner and a core layer, respectively;

FIG. 10 is a diagram depicting a ruling wheel assembly according to an embodiment of the present invention, wherein FIG. 10(A) shows a front view and FIG. 10(B) shows a side elevational view of the ruling wheel assembly, respectively;

FIG. 11 is a plan view of the ruling wheel assembly as disclosed in FIG. 10 when viewed from above;

FIG. 12A is a sectional view illustrating how a rule is produced in a corrugated cardboard blank sheet by the ruling wheel assembly as disclosed in FIG. 10, showing a condition of corrugated cardboard blank sheet sandwiched between respective ruling wheels so as for the rule to be formed therein;

FIG. 12B is a sectional view when the corrugated cardboard blank sheet as disclosed in FIG. 12A is folded in a mountain fashion;

FIG. 12C is a sectional view when the corrugated cardboard blank sheet as disclosed in FIG. 12A is folded in a valley fashion, showing the contour when the corrugated cardboard blank sheet has been folded properly;

FIG. 12D is another sectional view when the corrugated cardboard blank sheet as disclosed in FIG. 12A is folded in a valley fashion, showing the contour when the corrugated cardboard blank sheet has bent improperly;

FIG. 13 is a sectional view showing another example of a ruling wheel assembly;

FIG. 14 is a sectional view showing yet another example of a ruling wheel assembly;

FIG. 15 is a sectional view showing yet another example of a ruling wheel assembly;

FIG. 16 is a sectional view showing yet another example of a ruling wheel assembly;

FIG. 17 is a sectional view showing yet another example of a ruling wheel assembly;

FIG. 18 is a sectional view showing yet another example of a ruling wheel assembly;

FIG. 19 is a sectional view showing yet another example of a ruling wheel assembly;

FIG. 20 is a sectional view showing yet another example of a ruling wheel assembly;

FIG. 21 is a sectional view showing yet another example of a ruling wheel assembly;

FIG. 22 is a sectional view showing yet another example of a ruling wheel assembly;

FIG. 23 is a sectional view showing yet another example of a ruling wheel assembly;

FIG. 24 is a sectional view showing yet another example of a ruling wheel assembly;

FIG. 25 is a sectional view showing yet another example of a ruling wheel assembly; and

FIG. 26 is a side elevational view showing a condition where a body bulging is occurring in a packing box of the prior art.

### EXPLANATION OF THE REFERENCE NUMERALS

1 Corrugated cardboard blank sheet

1a packing box

3 Top panel

5 First long side panel

7 Bottom panel

9 Second long side panel

11 Joint flap

13, 17 Outer flap

K1, K2, K3, K4, K5, K6, K7 Rule

L1 Front liner

L2 Back liner

L3 Core layer

M1, M2, M3, M4 Ridge

M5, M6, M7, M8 Chamfered portion

P Perforations

401a Ruling wheel assembly

401b1, 401c1 Ruling wheel

401b2 Convex portion

401c2 Concave portion

K401 Rule

### PREFERRED EMBODIMENT OF THE INVENTION

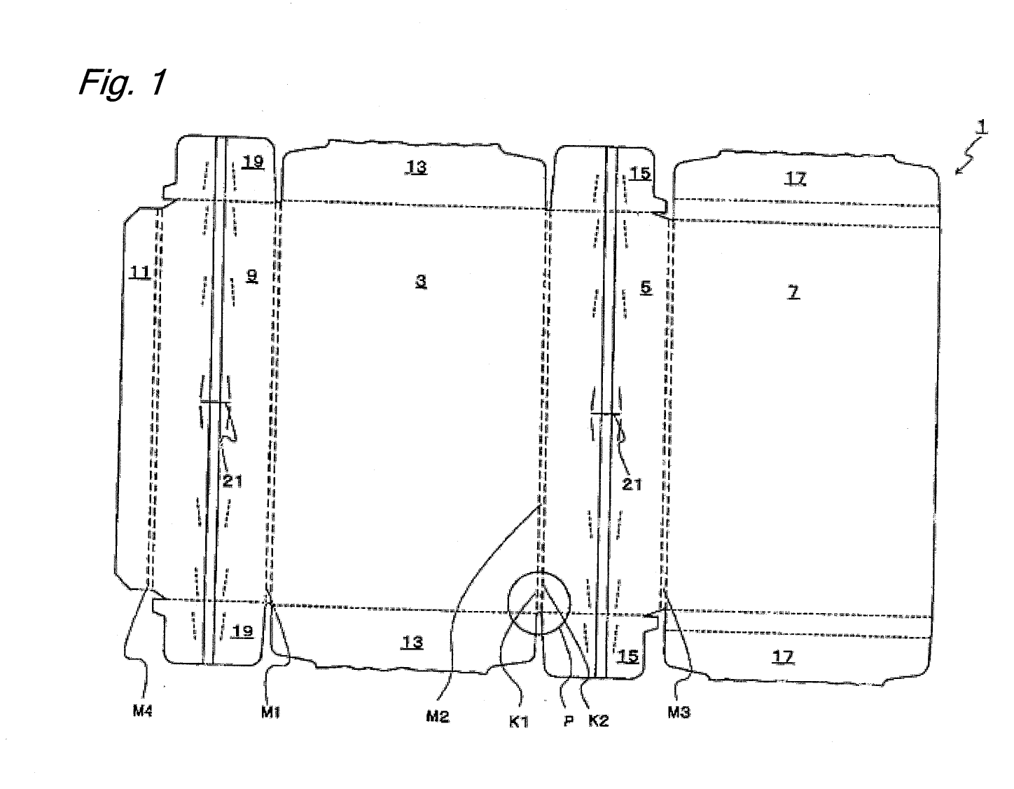

A packing box according to an embodiment of the present invention will now be described with reference to the attached drawings. Referring to FIG. 1, a corrugated cardboard blank sheet is shown, from which a packing box is formed.

[Corrugated Cardboard Blank Sheet]

A corrugated cardboard blank sheet 1 for a packing box according to the present embodiment comprises a top panel 3 to provide an upper surface when constructed into a packing box, a first and a second ridges, M1, M2 adjacent to the top panel 3, a first long side panel 5 coupled to the top panel 3 via the second ridge M2 interposed therebetween, a third ridge M3 adjacent to the first long side panel 5, a bottom panel 7 coupled to the first long side panel 5 via the third ridge M3 interposed therebetween and a fourth ridge M4 to be placed adjacent to the bottom panel 7 after the construction, as shown in FIG. 1. Further, the top panel 3 is coupled with a second long side panel 9 via a first ridge M1, and the second long side panel 9 is further coupled with a joint flap 11 via a fourth ridge M4. Further, the top panel 3 and the bottom panel 7 are coupled in their both sides (vertical ends in FIG. 1) with outer flaps 13 and 17, and respective first and second long side panels 5 and 9 are coupled in their both ends (vertical ends in FIG. 1) with inner flaps 15 and 19. Those outer flaps 13 and 17 as well as the inner flaps 15 and 19 may form a short side panel portion. In the illustrated embodiment, respective elements are not produced separately but produced as a corrugated cardboard blank sheet 1 having a geometry as shown in FIG. 1 that has been punched out from a single large corrugated cardboard blank sheet 1, then further added with folding rules in boundaries between respective elements. In this regard, the corrugated cardboard blank sheet may be produced by the punching out for the “wrap around” and by the cutting for the “201 type (A style)”. It is to be noted that although the packing box of the “wrap around” has been taken as an example for illustration, the present invention is applicable to packing boxes of other types than the “wrap around”.

[Top Panel and Bottom Panel]

The top panel 3 and the bottom panel 7 are members to be a top surface and a bottom surface once constructed into a packing box. Accordingly, if the goods contained in the packing box are canned beer containers or the like, they are sized to accommodate an array of predetermined number of canned beer containers. Specifically and by way of example, in the illustrated embodiment, they are sized to accommodate 4×6=24 of canned beer containers, each containing 350 ml. Accordingly, the top panel 3 and the bottom panel 7 have a rectangular shape with ratio of long side to short side being approximately 3:2.

[Joint Flap]

The joint flap 11 is coupled to the second long side panel 9 via the fourth ridge M4 and used to connect the second long side panel 9 to the bottom panel 7 when constructed into the packing box. Accordingly, the joint flap 11 is configured substantially in a trapezoidal shape and has a length substantially equal to the length of the forth ridge 4 and a length substantially equal to the length of the long side of the bottom plate 7.

[Long Side Panel]

Each of the long side panels 5 and 9 is a member to be a side surface (i.e., a vertical surface), when constructed into the packing box. A cut 21 is formed near the center of each of the long side panels 5 and 9. This cut 21 provides a site into which initially a finger(s) is inserted, when opening the packing box, and the cut 21 extends from a front surface to a back surface of the corrugated cardboard blank sheet 1 as punched through the corrugated cardboard. The cut 21 is configured substantially in an H-shape defined by a plurality of discontinuous section lines. This is intended to allow for a hole having a predetermined area to be created by inserting a finger into the site. However, this shape is presented by way of example only, but a simple linear shape of section line may be used.

[Ridge]

Respective ridges M1, M2, M3 and M4 will be now described.

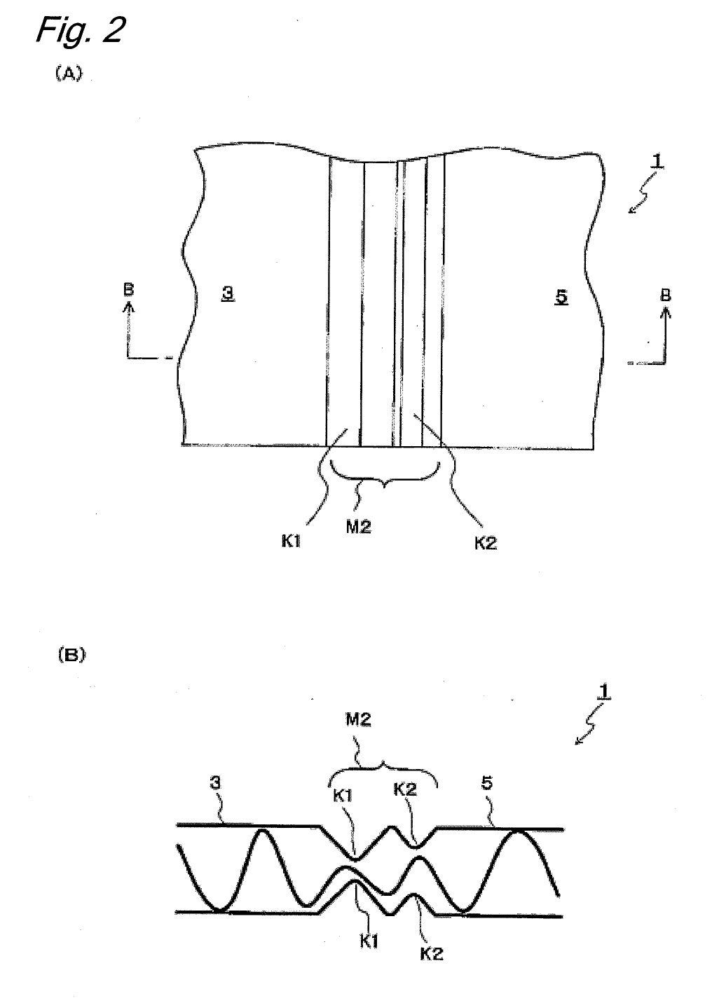

The ridges M1, M2, M3 and M4 are formed to be sandwiched between respective long sides of the top panel 3, the bottom panel 7 and the long side panels 5 and 9. FIG. 2 is an enlarged view of an encircled area P in FIG. 1, particularly illustrating a part of the second ridge M2. As shown in FIG. 2, the second ridge M2 is an area produced by two rule K1 and K2, which are parallel to each other. Each of the rules K1 and K2 is provided in order to allow the long side panel 5 to bend with respect to the top panel 3. Specifically, the rule K1, K2 represents an area of the corrugated cardboard blank sheet that has a reduced thickness by the press in the creasing process and thus has a lower rigidity as compared to an unprocessed area. Consequently, if a bending stress affects the corrugated cardboard blank sheet 1, the sheet may bent in the site of the rule K1, K2.

Further, the rules K1 and K2 are different in depth from each other. In an example as shown in FIG. 2(B) which is a sectional view taken along the B-B line of FIG. 2(A), the right rule K2 (in the boundary area with respect to the long side panel 5) is configured to be shallower. Thus, the use of the rules K1 and K2 that are different in depth from each other can provide an excellent effect, as will be described below. Specifically, since the rule K2 defined in the boundary with respect to the long side panel 5 is shallower, consequently the thickness of the corrugated cardboard blank sheet 1 in the boundary with respect to the first long side panel 5 should be thicker than that of the blank sheet in the boundary with respect to the top panel 3. Accordingly, the right rule K2 has a higher bending rigidity. If the bending stress is applied to the corrugated cardboard blank sheet 1 under such a condition as stated above, then the corrugated cardboard blank sheet 1 start to bend first at the rule K1 having the lower bending rigidity. Then, after the corrugated cardboard blank sheet 1 has bent along the rule K1, the bending along the rule K2 will start. Thus, the bending along one rule K1 has been once completed and then the bending along the other rule K2 starts, so the problem of potential serpentine folding line, the problem inherent to the related art, could be avoided even with an existing typical type of caser.

It is to be noted that the rule K2 located on the side of the long side panel 5 has been configured to be shallower in the present embodiment, but inversely, the rule K1 on the side of the top panel 3 may be configured to be shallower. Further, the rule K1, K2 need not be produced in both surfaces but may be simply formed at least either one of the front or the back surface of the corrugated cardboard blank sheet. In addition, although the above embodiment has been described by taking the case that has employed two rules as an example, three or more rule configured to be different in depth from an adjacent one, may be disposed in parallel, so that the corrugated cardboard blank sheet 1 can bend stepwise in respective areas defined by respective rules.

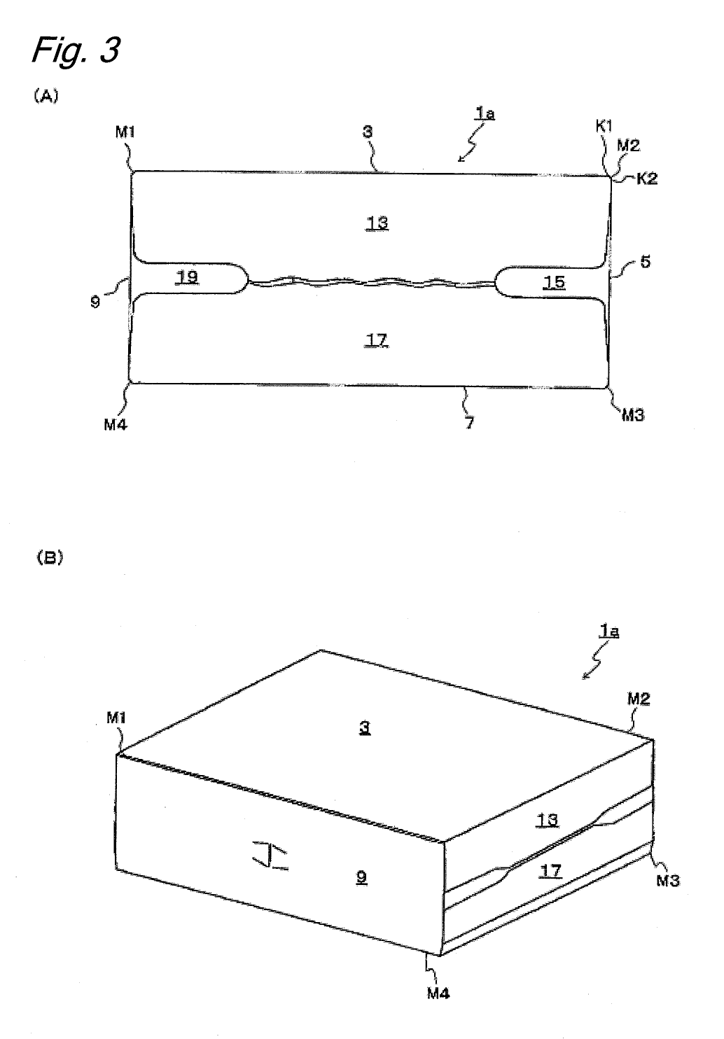

FIG. 3 depicts a packing box 1a constructed from the corrugated cardboard blank sheet 1 as described above, according to an embodiment of the illustrated embodiment, wherein FIG. 3(A) is a side elevational view and FIG. 3(B) shows a perspective view of the constructed packing box. As seen from FIG. 3(A), the first and the second ridges M1 and M2 are formed between the top panel 3 and respective long side panels 5 and 9, which are collapsed with the assist of the rules K1 and K2. Thus, with those ridges M1 and M2 at corners of the packing box 1a that have been collapsed, if any stacking load affects the packing box la, a resultant deformation in the direction of the load can be absorbed by rules K1 and K2 as they will be deformed appropriately, and consequently the phenomenon of body bulging can be effectively inhibited.

It is to be noted that in addition to the ridges M1 and M2 located between the top panel 3 and respective long side panels 5 and 9, there are the ridges M3 and M4 formed between the bottom panel 7 and respective long side panels 5 and 9, but the present invention is not limited to that. Specifically, the ridges may be exclusively formed on the side of the top panel 3 or on the side of the bottom panel 7. However, the ridges may be desirably formed in both sides of the top panel 3 or the both sides of the bottom panel 7. This is from the reason that if the ridge is formed exclusively in one side of the panel, there will be a possible imbalance in the absorption of deformation from the load.

### Second Embodiment

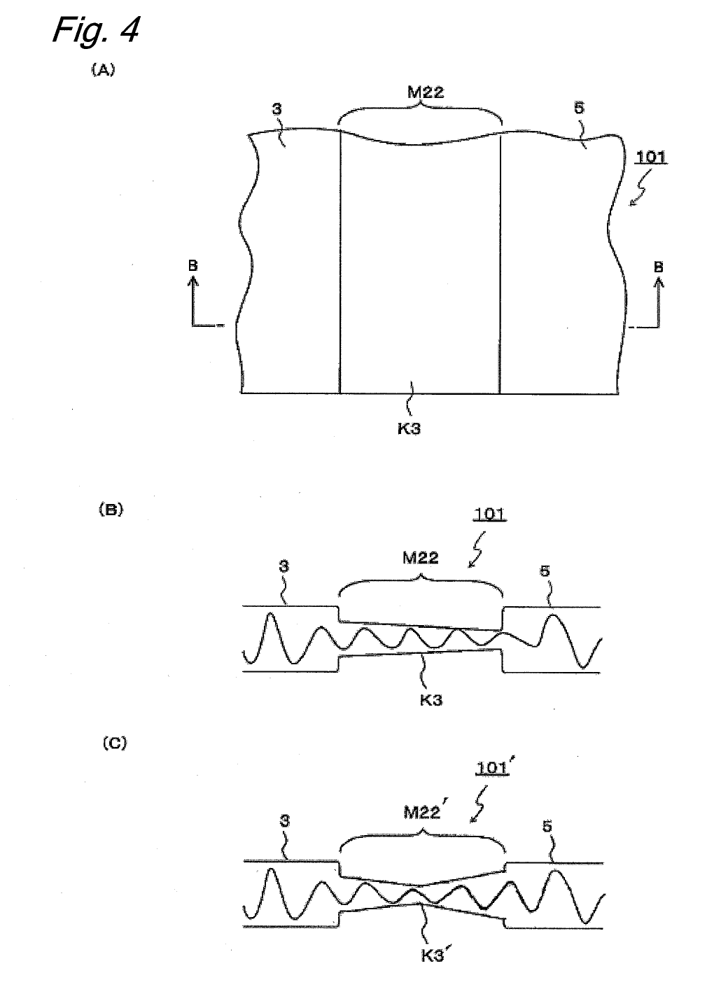

Turning now to FIG. 4, a second embodiment will be described. This second embodiment is different from the first embodiment in the structure of a rule K3. Specifically, as shown in FIG. 4(B), the present embodiment is characterized in comprising a single wide rule K3. With this design, the rule K3 will be directly formed into a ridge M22. To explain this in more detail, the rule K3 is formed in a site sandwiched between the top panel 3 and the long side panel 5. As it is, the rule K3 increases in its depth continuously from one side connecting to the top panel 3 toward the other side connecting to the long side panel 5. Consequently, the thickness of the corrugated cardboard blank sheet in the rule K3 is reduced proportionally toward the long side panel 5.

With the above described configuration employed, the following effects should be brought about. Specifically, since a corrugated cardboard blank sheet 101 has a most reduced thickness in the right end portion (boundary with respect to the long side panel 5) within the rule K3, therefore when the bending stress affects the corrugated cardboard blank sheet, it starts to bend first in the right end portion. Consequently, there will be no serpentine folding line to appear. In addition, as the bending stress is further applied, the bending action propagates along the width toward the left end (boundary with respect to the top panel 5) side within the rule K3. As a result, the ridge M22 can bend at a predetermined angle in the relationship with the long side panel 5, while it may bend in a moderate curvature along the surface in the direction toward the top panel 3. The packing box formed from the corrugated cardboard blank sheet 101 having the structure as described above can also inhibit the body bulging in a similar manner to the first embodiment with the aid of the ridge M22 as it can absorb the deformation of the packing box. It is to be noted that although the rule K3 is configured to be deepest in the right end portion in this embodiment, inversely it may be configured to be deepest in the left end portion. In addition, there is no need to form the rule K3 in both surfaces of the corrugated cardboard blank sheet 1, but it may be formed in either one of the front surface or the back surface of the sheet. Further, as shown in FIG. 4(C), a rule K3′ may be configured to be deepest in a widthwise middle point (shown in center in the drawing) between two ends and to be shallower in both end sides (may be equally or differently shallower in both ends) for forming a ridge M22′.

### Third Embodiment

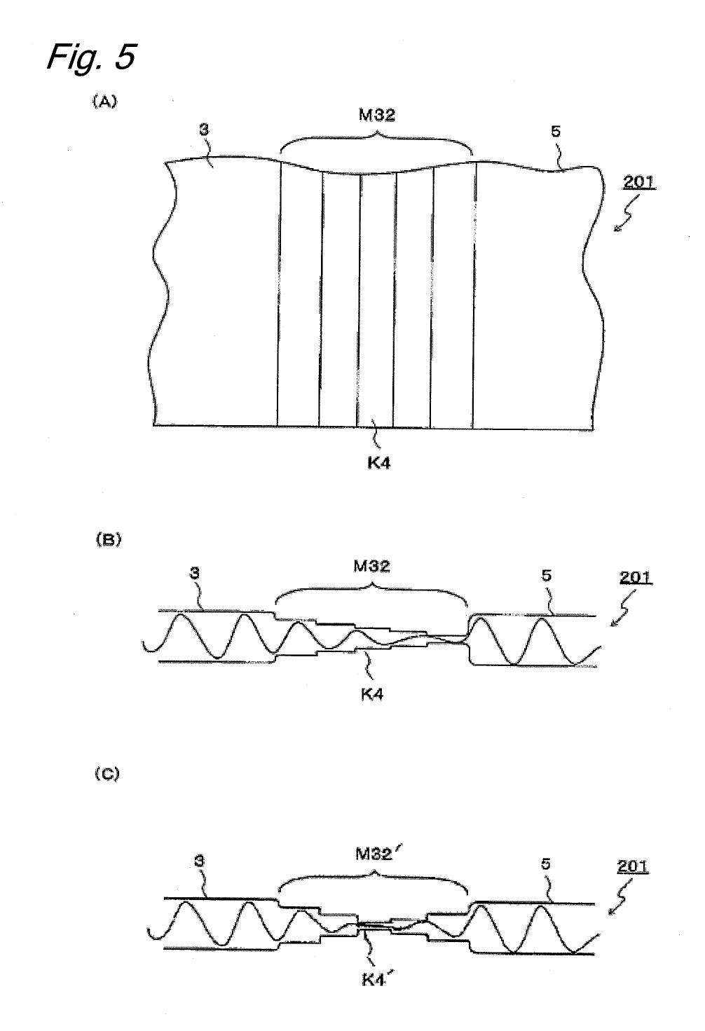

Turning now to FIG. 5, a third embodiment will be described. Although the third embodiment is similar to the second embodiment, it is different from the third embodiment in geometry of a cross section of a rule K4. Specifically, as shown in FIG. 5(B), the rule K4 has a depth that varies in steps and deepest in an area connecting to the long side panel 5. Consequently, the corrugated cardboard blank sheet 201 has a most reduce thickness in the area connecting to the long side panel 5. If such a corrugated cardboard blank sheet 201 experiences a bending stress, it starts to bend first in the boundary area with respect to the long side panel 5. Consequently, there will be no such problem of serpentine folding line to arise. Then, as the bending stress increases, the bending action propagates along the width toward the top panel 3 side within the rule. During that, since the thickness varies in steps within the K4, a resultant ridge M32 will appear to be bent and collapsed in such a cross section like a polygonal shape. The packing box formed from the corrugated cardboard blank sheet 201 having a structure as described above can also inhibit the body bulging in a similar manner to the first embodiment with the aid of the ridge M32.

It is to be noted that although the rule K4 is configured to be deepest in the right end portion in this embodiment, inversely it may be configured to be deepest in the left end portion. In addition, there is no need to form the rule K3 in both surfaces of the corrugated cardboard blank sheet 1, but it may be formed in either one of the front surface or the back surface of the sheet. Further, as shown in FIG. 5(C), a rule K4′ may be configured to be deepest in a widthwise middle area (shown in center in the drawing) between two ends and to be shallower in both end areas (may be equally or differently shallower in both ends) for forming a ridge M32′.

### Fourth Embodiment

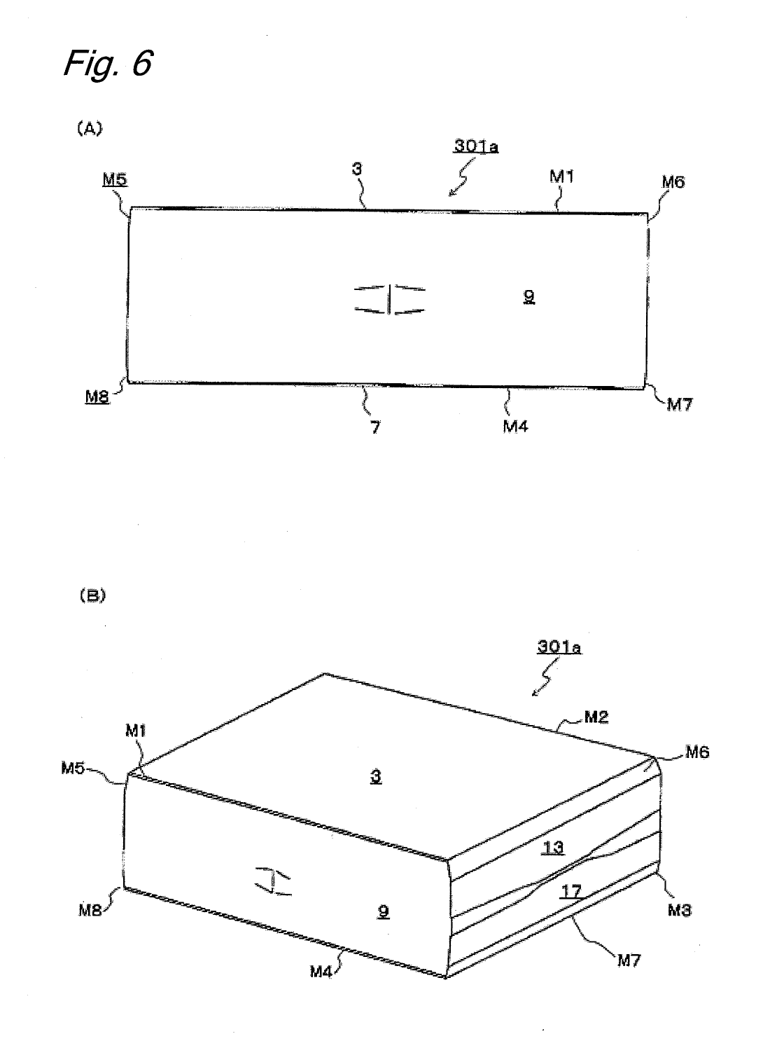

Turning now to FIG. 6, a fourth embodiment will be described. This illustrated embodiment represents a case where a chamfered portions M5, M6, M7 and M8 are further created in the outer flap 13 adjacent to the top panel 3 and the outer flap 17 adjacent to the bottom panel 7, respectively.

Thus, with the chamfered portions M5, M6, M7 and M8 created in the outer flaps 13 and 17, the phenomenon of body bulging can be effectively inhibited not only in the long side pales 5 and 9 but also in the side walls formed by the outer flaps 13 and 17.

It is to be noted that the chamfered portions M5, M6, M7 and M8 are created in the outer flap 13 located on the side of the top panel 3 and the outer flap 17 located on the side of the bottom panel 7 in this embodiment, but the present invention is not limited to that. Specifically, the chamfered portions may be created exclusively in the flap on the side of the top panel 3 or exclusively in the flap on the side of the bottom panel 7.

[Secondary Effect]

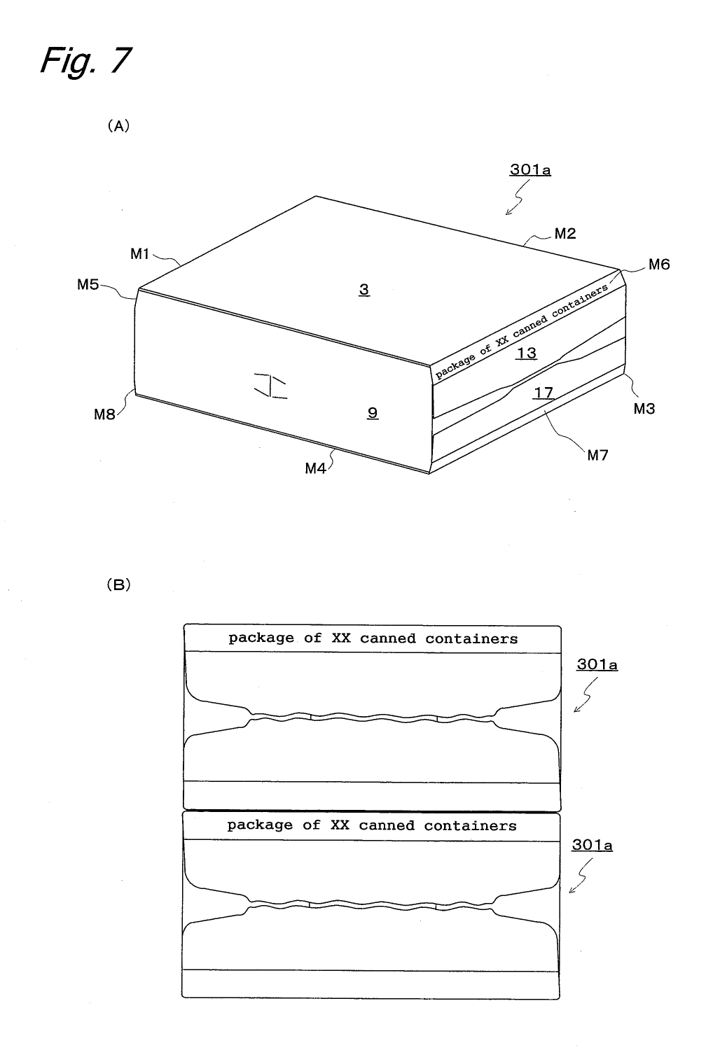

Turning now to FIG. 7, secondary effects from the arrangement of the chamfered portions M5, M6, M7 and M8 will be described. The present invention is primarily intended to inhibit the body bulging of a packing box 301a. However, the present invention not only works effectively to inhibit the body bulging but also provides secondary effects, as will be described below. Specifically, as shown in FIG. 7(A), the chamfered portion M6, for example, provides a space available for indication of instructions or advertisements. Since the chamfered portion M6 is a sloped surface, when viewing the packing box 301a placed on a floor or the like from diagonally above, the chamfered portion M6 can come into a direct view and would not be failed to recognize. The instructions or advertisements presented in the chamfered portion M6 can enhance the merchantability. Such an effect is provided equally, even if the packing boxes 301a are stacked as shown in FIG. 7(B).

In addition, as shown in FIG. 7(B), when a packing box 301a placed in an upper level in the stack of the packing boxes 301a is to be lifted up, the packing box 301a can be lifted up easily, as there will be a void secured between the upper and the lower packing boxes 301a with the aid of respective chamfered portions.

Yet further, having the chamfered portion may help save the required volume of corrugated cardboard blank sheet material as compared to the existing packing box having a rectangular parallelepiped configuration.

### Fifth Embodiment

Turning now to FIG. 8, a fifth embodiment of the present invention will be described. FIG. 8 is a perspective view showing a part of a rule K5, K6 in a corrugated cardboard blank sheet as before constructed into a packing box. As shown in the drawing, the corrugated cardboard blank sheet is composed of a front liner L1, a back liner L2 and a core layer L3 interposed between respective liners L1 and L2. Particularly, FIG. 8 shows a case where two rules K5 and K6 configured to be different in depth have been formed. As seen from FIG. 8, the deeper rule K5 is disposed in the left side and the shallower rule K6 is disposed in the right side.

Further, perforations P are formed within the shallower rule K6 (e.g. at a bottom) along the longitudinal direction of the rule K6. Particularly, they are exclusively formed in the front liner L1. Although the perforations P are formed to extend longitudinally across the full length of the rule K6, the present invention is not limited to that, but the perforations P may be formed partially along the length of the rule K6 or a predetermined length of perforations P may be exclusively formed in both end portions of the rule K6. Further, although the perforations P in the present embodiment are formed in a central area of the bottom of the rule K6, they may be formed at a location offset widthwise to either side of the rule K6.

Pitch of perforations P is about 3 mm, 2 mm for a slit segment and 1 mm for non-slit segment. However, the presented size of the perforation P is only by way of example in nature, but the perforation may be formed in any other patterns, including 4 mm pitch, 2 mm for the slit segment and 2 mm for the non-slit segment. Further, although a single line of perforations is used in the present embodiment, the number of lines of perforations is not specifically limited but two or more lines of perforations P may be used.

The perforations P, if formed within the rule K6 as described above, may work in the following manner. Specifically, the corrugated cardboard blank sheet will start to bend first at the deeper rule K5, when applied with a bending stress along the rules during the box manufacturing process. This is because in the rule K5, the front liner L1 and the back liner L2 are placed closely to each other owing to their deeper valleys and thus the rule K5 has a reduced rigidity as compared to the shallower rule K6. Consequently, as the bending stress increases, the bending action in the corrugated cardboard blank sheet will propagate along the deeper rule K5. Ultimately, when the bending stress exceeds a certain value, the shallower rule K6 now starts to bend. At this time, owing to the fact that the perforations P as described above have been formed in the shallower rule K6, the corrugated cardboard blank sheet, if made of material having a significant rigidity in itself, can be folded reliably along the rule K6, as the rigidity has been reduced by some degrees with the presence of the perforations P.

It is to be noted that the above description is directed to the case of the perforations P having been formed in the shallower rule K6 or in the one having a higher rigidity. However, the present invention is not limited to that. Specifically, the perforations P may dare to be formed in the deeper one or the rule K5. Based on the fact that in addition to the relatively low rigidity as compared to the shallower rule K6, the perforations P further reduces the rigidity of the rule K5, the above arrangement ensures the bending action occurring first with the aid of the deeper rule K5. This is advantageously useful for the case using the material having a significantly high rigidity in itself. However, it is desired that the similar perforations P should be also formed in the shallower rule K6 to facilitate the bending action.

It is further noted that although FIG. 8(A) shows a case where the perforations P are formed exclusively in the front liner L1, the present invention is not limited to that. Specifically, the perforations P may be similarly formed in the back liner L2 and the core layer L3 in addition to the front liner L1, as shown in FIG. 8(B). Alternatively, the perforations P may be formed in either one of the back liner L2 or the core layer L3. This arrangement is particularly useful for a case using a highly rigid material.

It is to be noted that the above description is directed to the case where two rules have been formed, but the present invention is not limited to that. Specifically, the present invention is applicable to such a packing box that has three or more rules formed therein. It is assumed, for example, that three rule configured to be different in depth have been formed in a ridge. Besides, they are different in depth from each other. In this case, if the perforations are formed at least in a shallowest rule, then bending at this shallow rule can be ensured, as well. Alternatively, the perforations may be formed only two of the three rules or may be formed in all of the rules. It is alternatively contemplated in one application that four rules are arranged and the perforations may be formed only two of the four rules. It is to be noted that the above combination is only given by way of example and many variations would be contemplated, depending on the number of rules.

### Sixth Embodiment

Turning now to FIG. 9, a sixth embodiment will be described. This embodiment is similar to the fifth embodiment in that the perforations P are formed in a rule K7 but different in that the rule 7 is a single line having a predetermined width. Although the rule K7 has a predetermined width, the depth of the rule K7 varies depending on the widthwise location. Specifically, presented is the case where the depth is reduced proportionally from the left to the right within the rule K7. Formation of the rule K7 by using such a configuration as stated above allows the bending to occur within the rule K7 first in the deeper side (left side in the drawing), in a similar manner as described in the second embodiment. Ultimately, when the bending stress exceeds a predetermined value, remaining portion within the rule K7 starts to bend, as well. During that, owing to the fact that the rule K7 has the perforations P formed in the shallower side and extending along the rule K7 and thus has its rigidity reduced with the presence of the perforations P, the bending action can occur reliably along the perforations P.

It is to be noted that the above description is directed to the case where the perforations P are formed in the shallower side (right side in the drawing) within the rule K7 or the side having a relatively high rigidity. However, the present invention is not limited to that. Specifically, the perforations P may dare to be formed in the deeper (left) side within the rule K7. Thus, based on the fact that in addition to the relatively low rigidity as compared to the shallower side within the rule K7, the perforations P further reduces the rigidity of the rule K7 in the deeper side, the above arrangement ensures the bending action occurring first along the deeper side within the rule K7. This is advantageously useful for the case using the material having a significantly high rigidity in itself. However, it is desired that the similar perforations P should be also formed in the shallower side within the rule K7 to facilitate the bending action.

Further, although FIG. 9(A) shows a case where the perforations P are formed exclusively in the front liner L1, the present invention is not limited to that. Specifically, the perforations P may be similarly formed in the back liner L2 and the core layer L3 in addition to the front liner L1, as shown in FIG. 9(B). Alternatively, the perforations P may be formed exclusively in either one of the back liner L2 or the core layer L3. This arrangement is particularly useful for a case using a highly rigid material.

It is to be noted that in the above embodiments (see FIGS. 1 to 9) the description is directed to the case where the rule is formed in both of the front liner and the back liner, but the present invention is not limited to that. Specifically, the present invention is also applicable to a case where the rule is formed exclusively in either one of the front liner or the back liner.

[Ruling Wheel]

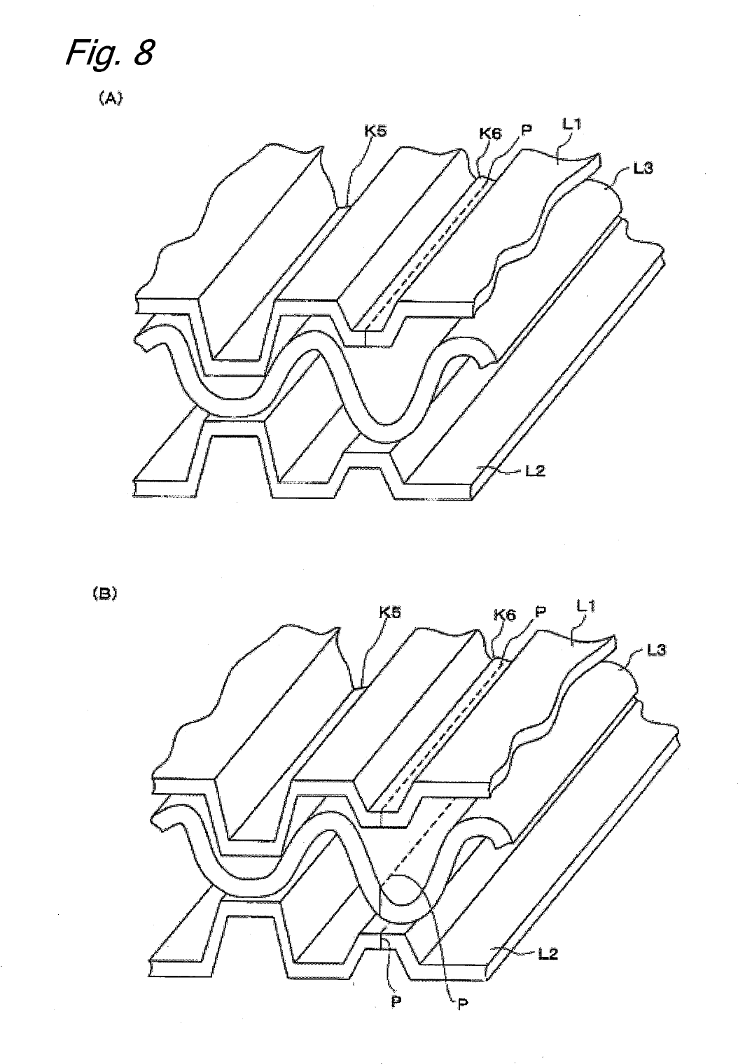

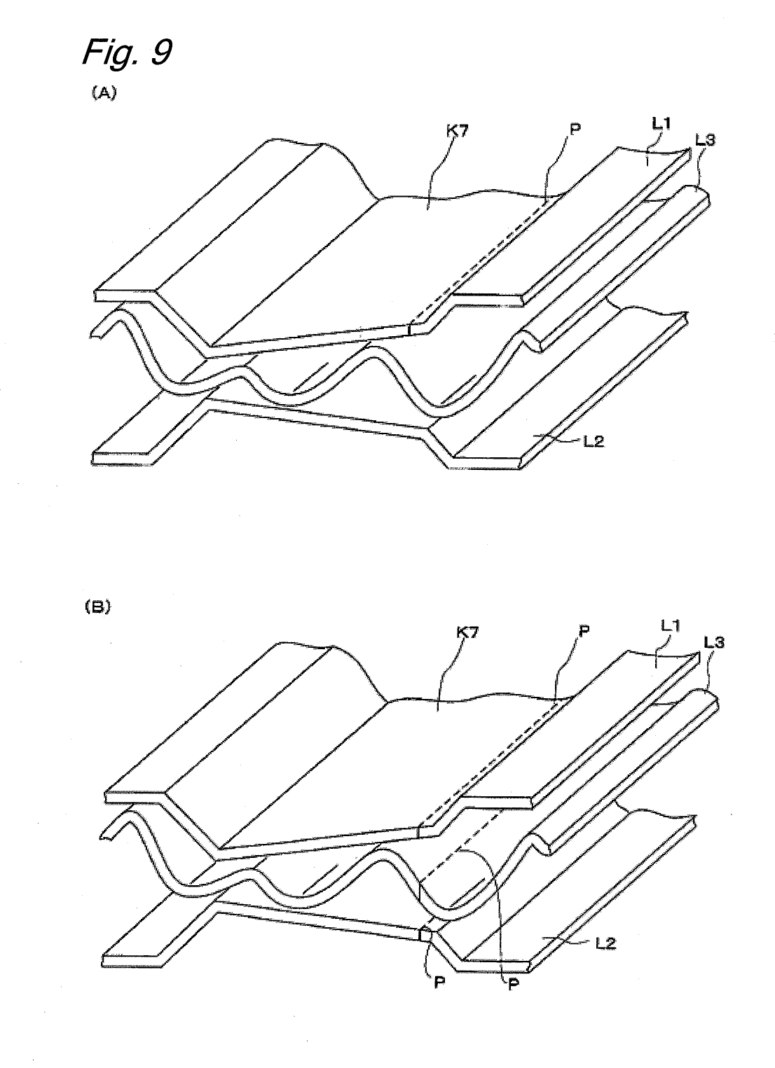

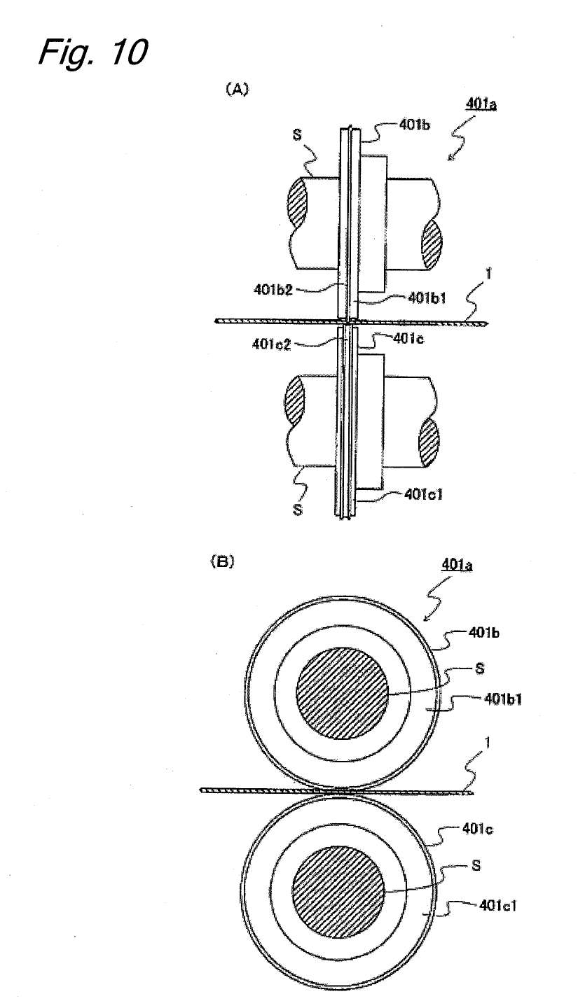

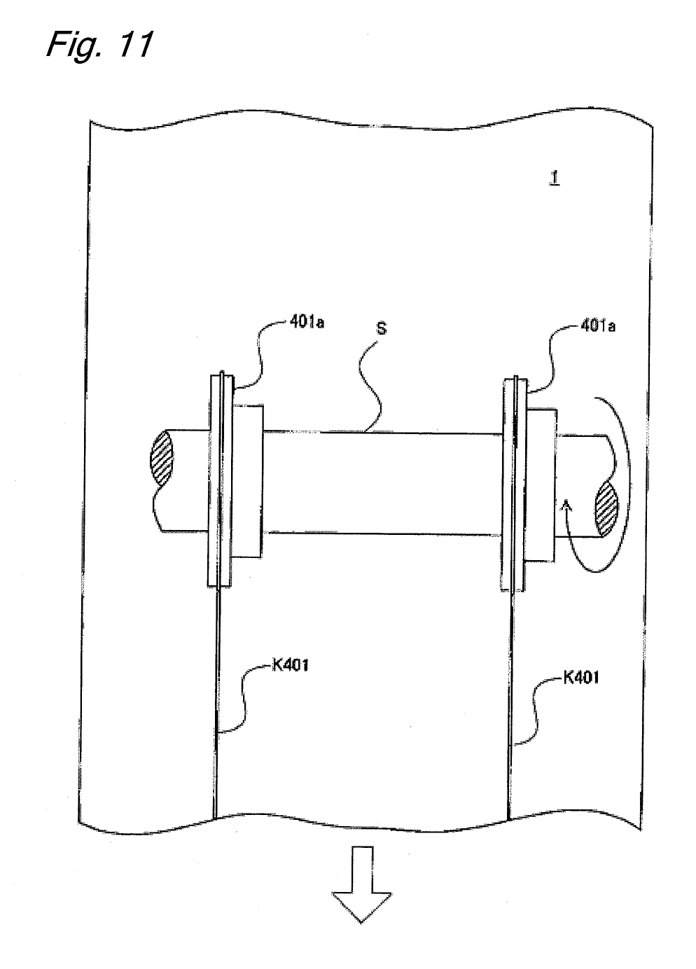

Turning now to FIG. 10, a ruling wheel assembly 401a for producing a rule K401 in the corrugated cardboard blank sheet 1 will be described. The ruling wheel assembly 401a as discussed herein refers disc- (or roller-) like members 401b and 401c as shown in FIG. 10, wherein two ruling wheels 401b and 401c are positioned with their side surfaces proximal to each other to provide the ruling wheel assembly 401a. As they are thus positioned and the corrugated cardboard blank sheet 1 goes through between the two ruling wheels, the rule K401 can be produced. Main components of the ruling wheel 401b, 401c include a disc- (or roller-) like ruling wheel body 401b1, 401c1 and a convex or a concave portion 401b2, 401c2 provided along the side surface of the ruling wheel body 401b1, 401c1. The ruling wheel 401b, 401c is fit over a rotatable shaft S for rotational motion. It is to be noted that in the present embodiment, two sets of ruling wheel assemblies are provided as per a single corrugated cardboard blank sheet 1, as shown in FIG. 11. However, when the rules are to be formed in a multiple number of corrugated cardboard blank sheets that may be cutout simultaneously from the base sheet material, the number of ruling wheel assemblies to be used may be increased, for example, four sets, six sets, . . . of the ruling wheel assemblies may be used. Further, it is also contemplated not only two sets of ruling wheel assemblies but also a multiple number of sets, such as three or four sets, of ruling wheel assemblies may be provided as per a single piece of the corrugated cardboard blank sheet (when a single corrugated cardboard blank sheet is cutout at once).

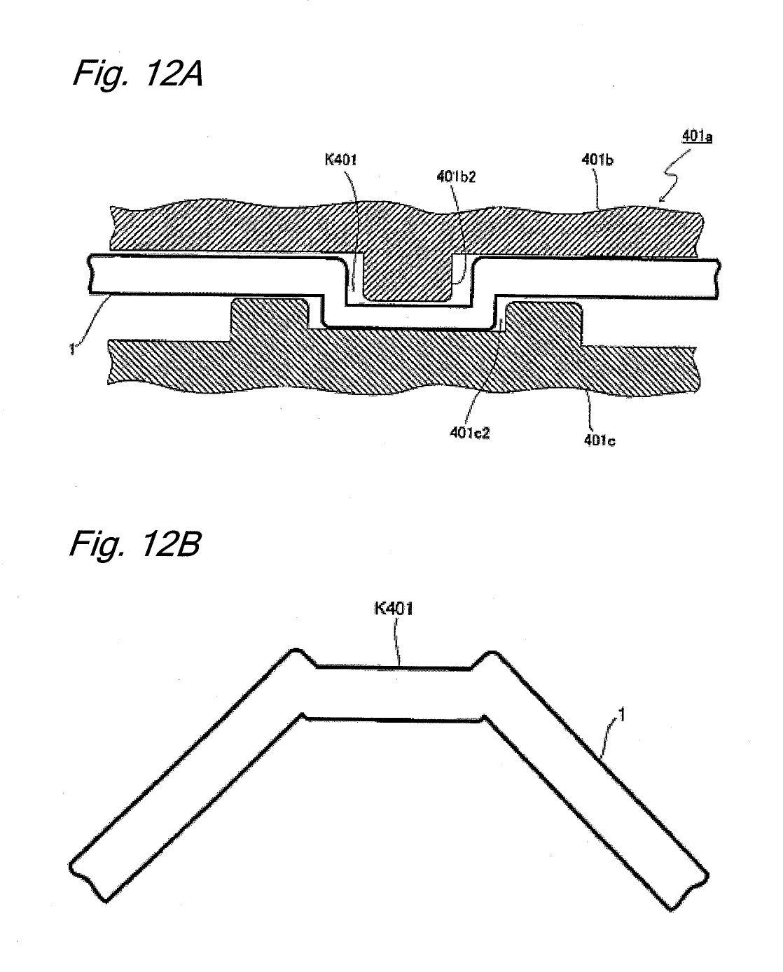

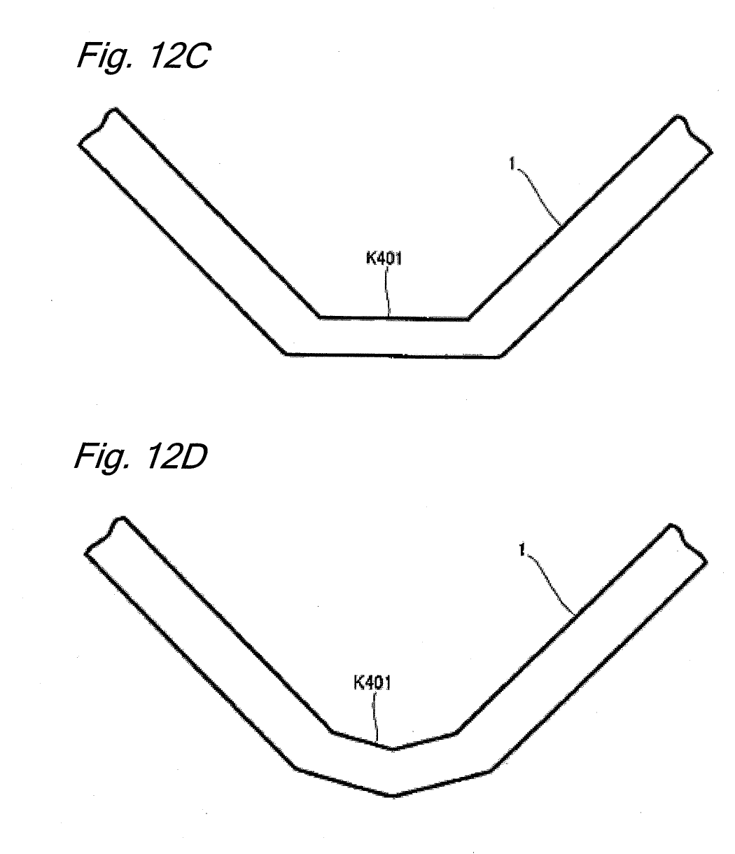

The description is now directed to the convex and the concave portions 401b2 and 401c2 formed on the ruling wheels 401b and 401c, respectively. FIG. 12(A) is an enlarged sectional view of the ruling wheel assembly 401a in an area where the ruling wheels 401b and 401c are positioned proximally to each other. The corrugated cardboard blank sheet 1 is herein shown to be sandwiched between respective ruling wheels 401b and 401c. In the drawing, an upper surface of the corrugated cardboard blank sheet 1 is defined on the side which will be folded in a mountain fashion during construction, or a rule to appear in an outer side, when constructed into a box configuration, for example. As shown in FIG. 12(A), in the ruling wheel assembly 401a of the present embodiment, a single row of convex portion 401b2 is formed in one (upper) ruling wheel 401b, while the concave portion 401c2 opposing to the above-mentioned convex portion 401b2 is formed in the other (lower) ruling wheel 401c. In this arrangement, the convex portion 401b2 of the ruling wheel 401b may be sized to be 2 mm wide and 0.8 mm high, for example. The corresponding concave portion 401c2 may be sized to be 5 mm wide and 1mm deep. Those sizes are presented only by way of example, but other sizes of the convex or concave portion may be employed depending on the specific properties of the corrugated cardboard blank sheet, the specific size of the desired rule to be formed or the like.

In case of using such a ruling wheel as shown in FIG. 12(A), a rule in a concave channel configuration K401 will be produced in the corrugated cardboard blank sheet 1 in its upper surface. Subsequently, this corrugated cardboard blank sheet is folded in a mountain fashion at the rule K401, and a predetermined flat surface may be created in a corner by the rule K401 having a predetermined width. Consequently, upon constructed into the box configuration, a chamfered area appears in the corner, which can help inhibit the body bulging effectively. Just for reference, an exemplary case where the rule K401 is folded in a valley fashion is presented in FIGS. 12(C) and 12(D). FIG. 12(C) shows the case of being properly folded in the valley fashion, and the folding as properly as shown in the drawing can inhibit the body bulging. On the other hand, FIG. 12(D) shows a case where the corrugated cardboard blank sheet 1 has been unsuccessfully bent in the site which should have been formed into the chamfered area, and with such a bending contour, the body bulging could be occasionally unavoidable.

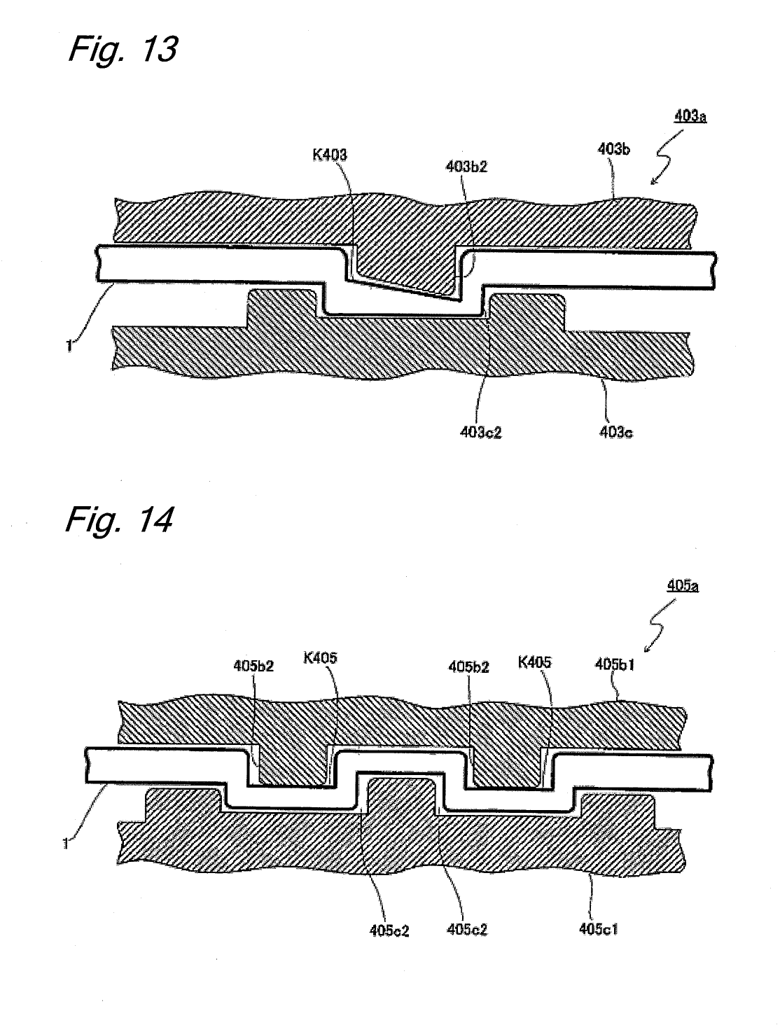

FIG. 13 shows a case where the convex portion 403a2 of the one ruling wheel 403a1 is beveled. Specifically, the convex portion 403a2 has a continuously varying height with respect to an axial direction of the rotatable shaft of the ruling wheel 403b. In the present embodiment, the bevel is shown to be low in the left side and high in the right side. Accordingly, when the rule K403 is produced by using the one ruling wheel 403a1, a single rule K403 with widthwise varying depth will be produced in the front surface of the corrugated cardboard blank sheet 1, as shown in FIG. 13. In this regard, since the rule K403 is deeper in the right side, the corrugated cardboard blank sheet, if folded in a mountain fashion at the rule K403, will start to bend first from the right side, and thus the potential serpentine folding line can be avoided effectively.

FIG. 14 shows a case where two rows of convex portions 405b2 are provided in one ruling wheel 405b1, while two rows of concave portions 405c2 corresponding to said convex portions 405b2 are provided in the other ruling wheel 405c1. If such a ruling wheel assembly 405a is used, two rows of rules K405 in a concave channel configuration will be produced in the front surface of the corrugated cardboard blank sheet 1. Consequently, when the corrugated cardboard blank sheet is folded in a mountain fashion along the two rows of rules K405, a flat area will be produced between respective rules K405, for example, said flat area defining a chamfered portion, when constructed into a box configuration.

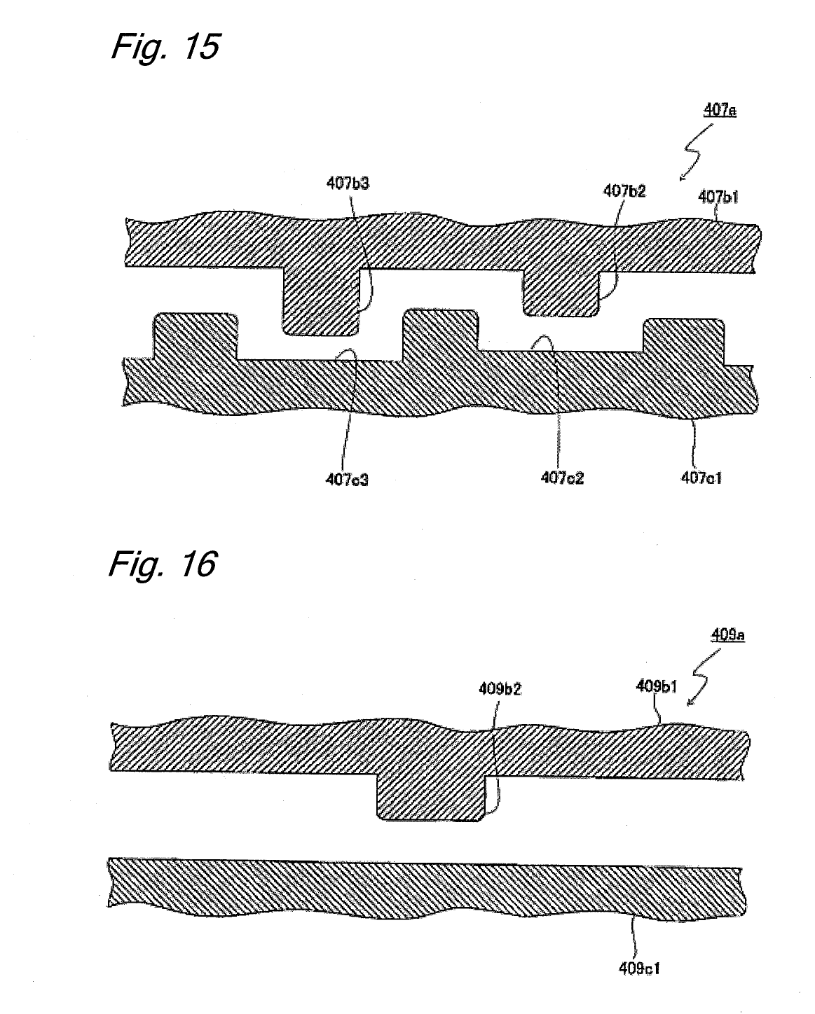

FIG. 15 represents a case that is similar to FIG. 14 in that a ruling wheel assembly 407a comprises convex portions 407b2 and 407b3 and concave portions 407c2 and 407c3, but in which the convex portions 407b2 and 407b3 are different in height and the concave portions 407c2 and 407c3 are different in depth from each other. When using such a ruling wheel assembly 407a, rules having different depth will be produced in the front surface of the corrugated cardboard blank sheet. Specifically, the rule produced in the left side will be deeper and the rule produced in the right side will be shallower. Thus, when the corrugated cardboard blank sheet with the rules configured to be different in depth is folded in a mountain fashion at those rules, it will bend first in the site where the deeper rule is produced, specifically along the left rule, and then bend along the shallower (right) rule. Consequently, the serpentine folding line could be avoided.

FIG. 16 represents a case that a single convex portion 409b2 is formed on one ruling wheel 409b1 similar to such case of ruling wheel assembly as shown in FIG. 12, but that the other (lower) ruling wheel 409c1 has no concave portion formed thereon. Specifically, a side surface of the other ruling wheel 409c1 provides a plain circumferential surface. When using such a ruling wheel assembly 409a to produce a rule, the rule do appear in the front surface of the corrugated cardboard blank sheet but the back surface will remain flat.

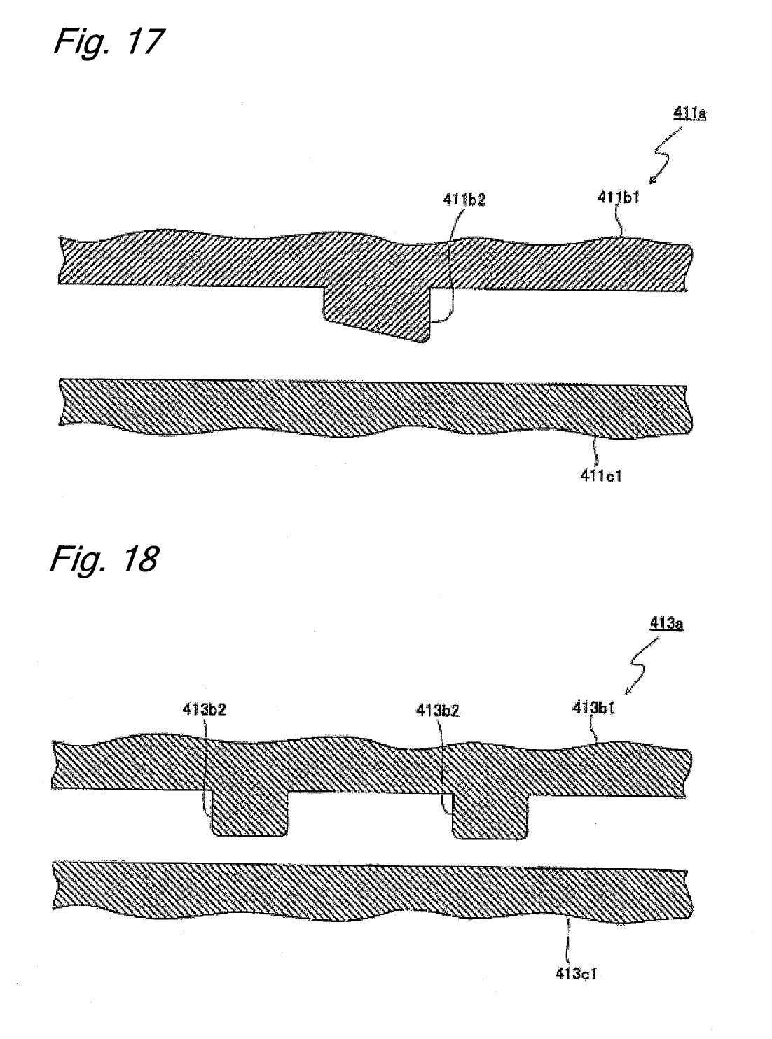

FIG. 17 represents a case that is similar to the ruling wheel assembly of FIG. 16 in that a single convex portion 411b2 is formed on one ruling wheel 411b1 but in which the one ruling wheel 411b1 has a convex portion 411b2 with a bevel that is similar to that as shown in FIG. 13. As it is, a side surface of the other ruling wheel 411c1 provides a plain circumferential surface. With such a ruling wheel assembly 411a, it will be possible to produce a rule whose depth varies depending on the location with respect to the width direction in the front surface of the corrugated cardboard blank sheet, while allowing the back surface of the corrugated cardboard blank sheet to remain substantially flat.

FIG. 18 shows a case that two convex portions 413b2 equal in height are formed on one ruling wheel assembly 413a1 similar to such case of ruling wheel assembly as shown in FIG. 14 but that there is no concave portion formed on the other (lower side) ruling wheel 413c1. Specifically, a side surface of the other ruling wheel 413c1 provides a plain circumferential surface. When using such a ruling wheel assembly 413a to produce a rule, two equally deep rules will be produced in the front surface of the corrugated cardboard blank sheet, while the back surface will remain substantially flat.

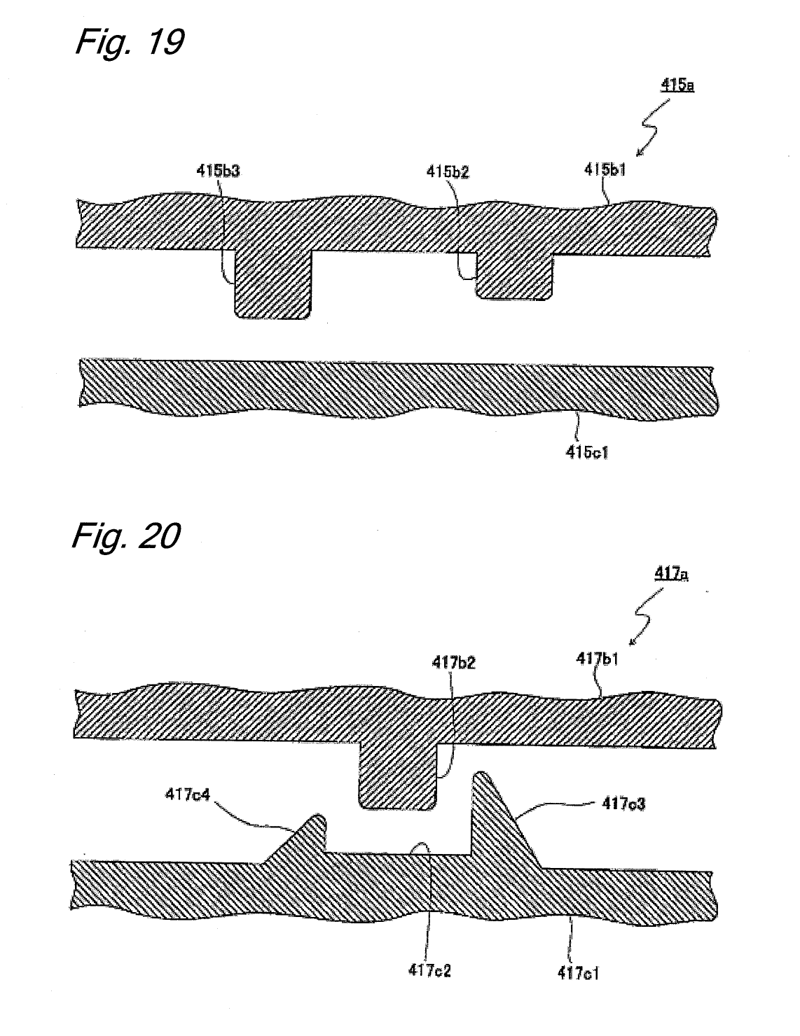

FIG. 19 represents a case that is similar to the ruling wheel assembly as shown in FIG. 18 in that two convex portions 415b2 and 415b3 are formed in one ruling wheel 415a but in which the two convex portions are different in height. With such a ruling wheel assembly, differently deep rules are produced in the front surface of the corrugated cardboard blank sheet. Specifically, the left rule will appear to be deeper and the right rule will appear to be shallower. Thus, when the corrugated cardboard blank sheet having the differently deep rules produced therein is folded in a mountain fashion at the rules, it will start to bend first in the side where the deeper rule is produced or specifically bend initially along the left rule and subsequently along the shallower (right) rule. Consequently, the serpentine folding line can be avoided. In addition, the back surface of the corrugated cardboard blank sheet will remain substantially flat.

FIG. 20 represents an example characterized in protrusions 417c3 and 417c4 together forming concave portion 417c2 provided in the other ruling wheel 417c1. Specifically, this is the example in which two protrusions 417c3 and 417c4 for forming the concave portion 417c2 are tapered toward their tips. In addition, those two protrusions 417c3 and 417c4 are different in height from each other. When using such a ruling wheel assembly 417a to produce a rule, similar effect to that in the case as shown in FIG. 19 can be obtained, as well.

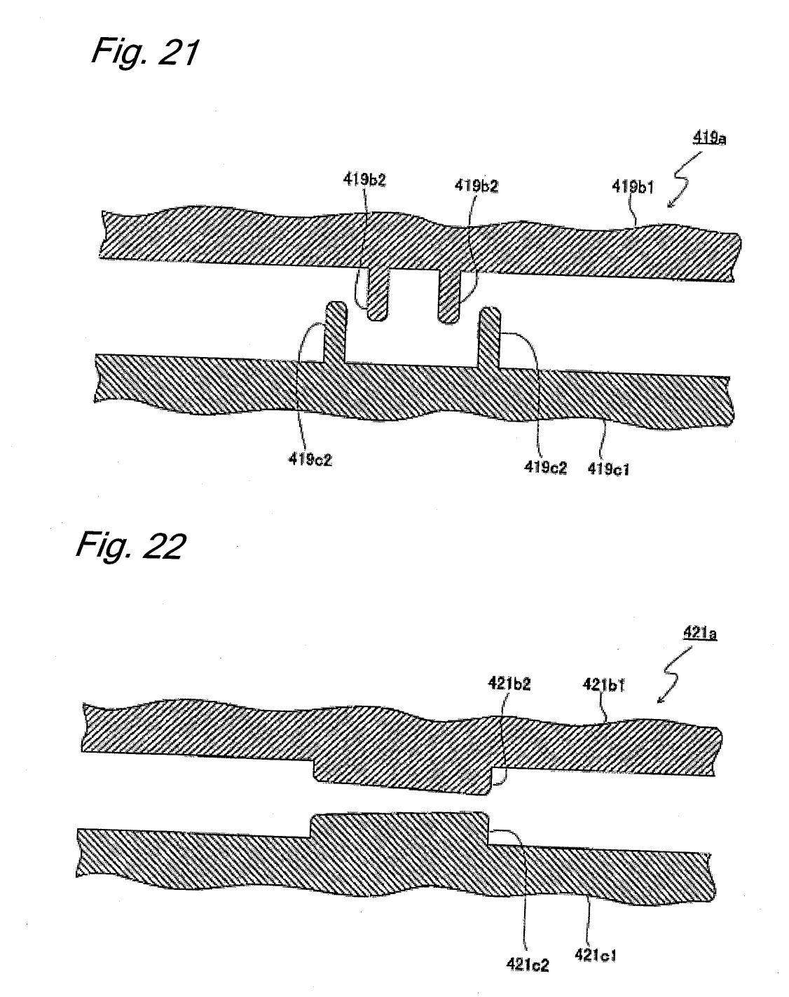

Referring to FIG. 21, two rows of thin first protrusions 419b2 are formed on one ruling wheel 419b1 and two rows of second protrusions 419c2 are formed on the other ruling wheel 419c1, which are positioned to sandwich said two rows of first protrusions 419b2 therebetween. When using such a ruling wheel assembly to produce a rule, a similar effect to that in the case as shown in FIG. 19 can be obtained.

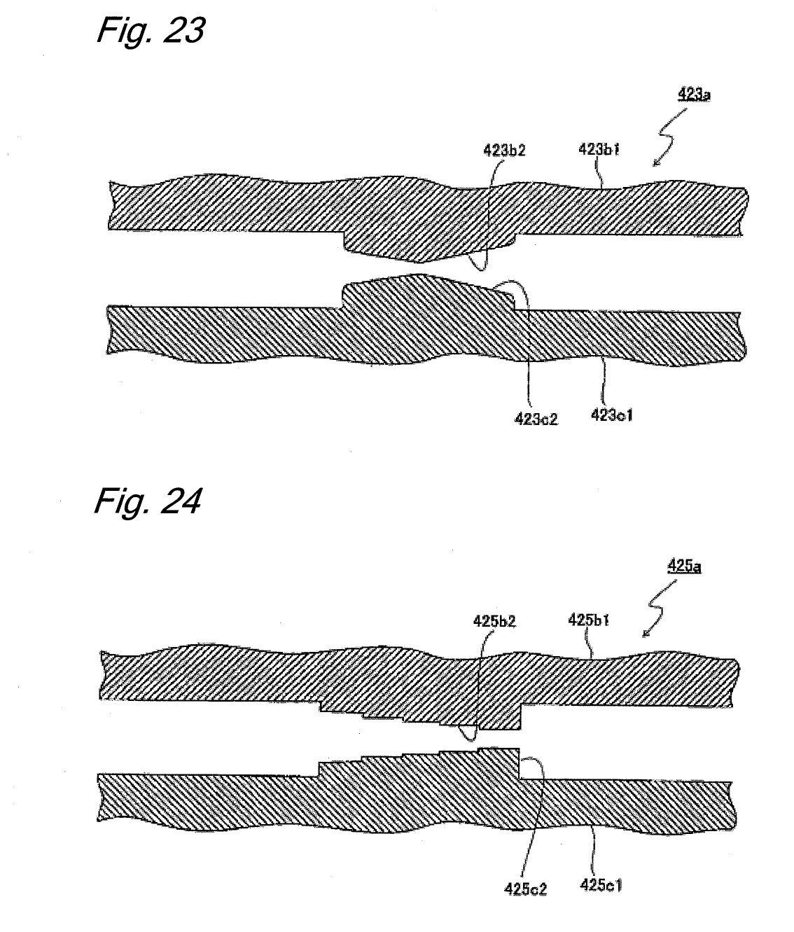

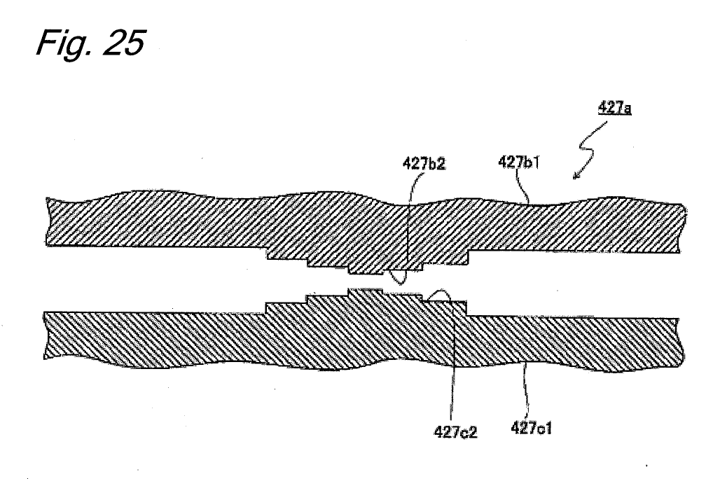

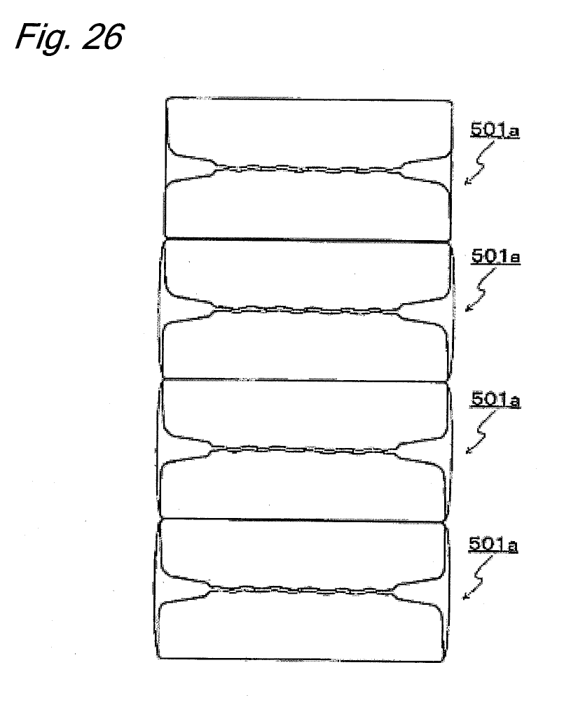

FIG. 22 is a sectional view showing an area in a ruling wheel assembly 421a where two ruling wheels are positioned proximally to each other for producing a rule as shown in FIG. 4(B). FIG. 23 is a sectional view showing an area in a ruling wheel assembly 423a where two ruling wheels are positioned proximally to each other for producing a rule as shown in FIG. 4(C). FIG. 24 is a sectional view showing an area in a ruling wheel assembly 435a where two ruling wheels are positioned proximally to each other for producing a rule as shown in FIG. 5(B). Further, FIG. 25 is a sectional view showing an area in a ruling wheel assembly 437a where two ruling wheels are positioned proximally to each other for producing a rule as shown in FIG. 5(C).

### INDUSTRIAL APPLICABILITY

The present invention may be applied to a manufacturing of a packing box used for packaging goods, such as canned containers, to a corrugated cardboard blank sheet to be formed into said packing box, and further to a ruling wheel for producing a rule in the corrugated cardboard blank sheet.

1. A packing box having a top panel, a bottom panel, two long side panels and two short side panels, said packing box characterized in that
at least either one of a ridge defined between said top panel and said long side panel or a ridge defined between said bottom panel and said long side panel is formed by at least two parallel rules configured to be different in depth from adjacent one.

2. A packing box having a top panel, a bottom panel, two long side panels and two short side panels, said packing box characterized in that
at least either one of a ridge defined between said top panel and said long side panel or a ridge defined between said bottom panel and said long side panel is formed by a single rule having a predetermined width and having a varying depth depending on its widthwise location.

3. A packing box in accordance with claim 2, characterized in that the depth of said rule varies continuously.

4. A packing box in accordance with claim 2, characterized in that the depth of said rule varies in steps.

5. A packing box in accordance with claim 1, characterized in that perforations are formed at least in either one of said at least two parallel rules configured to be different in depth from adjacent one, said perforations running along said rule.

6. A packing box in accordance with claim 5, characterized in that said perforations are formed at least in a shallowest rule.

7. A packing box in accordance with claim 2, characterized in that perforations are formed in either one of a deeper side or a shallower side of said single rule having a varying depth depending on its widthwise location, said perforations running along said rule.

8. A packing box in accordance with claim 7, characterized in that said perforations are formed in a shallower side within said rule.

9. A ruling wheel assembly characterized in comprising,
one of ruling wheels in a disc- or roller-like configuration having a convex portion on its side surface; and
the other of said ruling wheels in a disc- or roller-like configuration whose side surface provides a circumferential surface or a concave portion to mate with said convex portion of said one of said ruling wheels, in which
said one and said the other of said ruling wheels are supported on respective rotatable shafts extending parallel to each other and positioned so that said side surfaces thereof are proximal to each other, wherein
a rule is produced in a paper material by said ruling wheel provided with said convex portion.

10. A ruling wheel assembly in accordance with claim 9, characterized in that an end surface of said convex portion is beveled with respect to an axial direction of said rotatable shaft.

11. A ruling wheel assembly in accordance with claim 9, characterized in comprising,
two pairs of said convex and concave portions are provided on said one and said the other of said ruling wheels.

12. A ruling wheel assembly in accordance with claim 11, characterized in that said two convex portions are different in height from each other.

13. A ruling wheel assembly in accordance with claim 11, characterized in that said two concave portions are different in depth from each other.

14. A ruling wheel assembly in accordance with claim 9, characterized in that said concave portion is formed by two protrusions provided on said the other of said ruling wheels, said protrusions tapered toward tips thereof.

15. A ruling wheel assembly in accordance with claim 9, characterized in that said convex portion is formed by two first protrusions and said concave portion is formed by two second protrusions disposed to sandwich said two first protrusions therebetween.

16. A corrugated cardboard blank sheet characterized in that a rule has been produced by a ruling wheel assembly in accordance with claim 9.

17. A packing box characterized by being formed from a corrugated cardboard blank sheet in accordance with claim 16.

18. A packing box in accordance with claim 17, characterized in that said corrugated cardboard blank sheet has been folded in a mountain fashion at a rule produced by a ruling wheel provided with said convex portion.
